(19) United States
(12) Patent Application Publication
(10) Pub. No.: US 2008/0185429 A1
(43) Pub. Date: Aug. 7, 2008

(54) Authentication Of PIN-Less Transactions

(75) Inventor: Julie Saville, Cardiff by the Sea, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/671,219

(22) Filed: Feb. 5, 2007

(51) Int. Cl. G06K 5/00

(52) U.S. Cl. 235/380; 705/26

(57) ABSTRACT

Systems for enrolling and authenticating transaction cards for PIN-less transactions are disclosed. Enrollment may include subjecting a cardholder to questions regarding previous transaction card transactions and then associating and storing a physical identifier with the transaction card. After enrollment, the cardholder may use the transaction card for PIN-less transactions, for example on the Internet, by successfully providing a physical identifier or pass code that matches the stored physical identifier that was used to enroll the transaction card. Different cardholders may send different types of physical identifier, for example, biometric samples, PC signatures and the like. In yet other embodiments, the system may direct a cardholder to the cardholder's financial institution webpage for authentication of a PIN-less transaction without requiring the cardholder to send a physical identifier. The financial institution may require any authentication they deem sufficient to permit a PIN-less transaction card transaction.

### BACKGROUND OF THE INVENTION

This disclosure relates in general to secure Internet transactions using an open loop debit card network and, but not by way of limitation, to enrollment and authentication of Automatic Teller Machine (ATM) cardholders or debit card cardholders for Internet transactions without requiring Personal Identification Numbers (PINs) amongst other things. In this context, debit card networks refer to financial networks that primarily process ATM and point-of-sale transactions that require PIN entry for authentication, as opposed to networks that primarily require signatures for cardholder authentication. Debit networks are additionally known for their single message, guaranteed-funds transaction processing architecture.

The development of the Internet and Internet shopping in particular has led to increased developments in Internet security and secure transactions in eCommerce. Most Internet transactions are completed using credit cards, signature debit cards or other payment schemes such as PayPal or Google Checkout. Due to the high cost of introducing PIN-protecting hardware or software, ATM/Debit card payments that require PIN entry have been limited on the Internet. Security experts have advised against allowing PIN entry on PCs due to the risk of fraudsters capturing this information, and then using the transaction card and PIN information to create fraudulent plastic cards to obtain cash at an ATM, thus draining the victims' checking or savings accounts. Debit card networks do allow ATM/Debit cardholders to make card payments—without entering the associated PIN—to companies that cardholders already have relationships with—such as utilities, which mitigates the risk of fraud. Debit card network transactions are typically authenticated, often using a PIN, and authorized at a financial institution.

Due to the heightened risk related to ATM/Debit cards requiring PIN entry along with the spread of eCommerce and the desire to incorporate more security and transaction efficiencies, there is a general need for a technical solution to handle ATM/Debit card transactions over a debit network that do not require entry of a PIN.

### BRIEF SUMMARY OF THE INVENTION

One embodiment of the present invention includes a system for enrolling a cardholder for PIN-less transaction card transactions. The system may include a storage location and a financial network host computer system. The financial network host computer system includes a network adapter and a processor. The processor may include instructions to enroll a transaction card for PIN-less Internet transactions. The system, in response to a request from a cardholder to enroll themselves for use of a transaction card for PIN-less Internet transactions, may retrieve past transaction card transactions associated with the transaction card from a transaction card transaction storage module. The system may then provide to a cardholder a listing of transaction card transactions. This listing may include at least one true transaction card transaction selected randomly from past transaction card transactions within a predetermined time period and at least one fictitious transaction card transaction. The cardholder may be queried over the Internet to select at least one true transaction card transaction from the listing of at least one true transaction card transaction and at least one fictitious transaction card transaction. The cardholder's selection is received by the system and verifies the selected transaction corresponds to at least one of the true transaction card transactions. If the cardholder was successful, the system receives a physical identification sample from the cardholder that is then hashed and stored.

Another embodiment of the invention includes a system for authenticating a cardholder using a transaction card in an Internet transaction between the cardholder and a merchant through a financial network. The system may include a storage location and a financial network host computer system. The financial network host computer system includes a network adapter coupled with the financial network and a processor. The processor may include instructions to enroll and authenticate a cardholder for use of a transaction cards for PIN-less Internet transactions. The system may receive a transaction request from a merchant for an Internet transaction between the merchant and a cardholder using a transaction card. The system may then confirm that the transaction card is enrolled for use in PIN-less Internet transactions and has at least one stored physical identification hash associated with the transaction card stored in electronic storage. A physical identification sample may then be received from the cardholder and then hashed. At least one stored physical identification hash associated with the transaction card may then be received from electronic storage and compared with the hash of the received physical identification sample. If the two hashes match, then the system may send authorization for the PIN-less transaction card transaction to the merchant if the physical identification sample matches the stored physical identification sample.

Another embodiment may include a system for authenticating a cardholder for use of a transaction card without a PIN in an Internet transaction between the cardholder and a merchant through a financial network. The system may include electronic storage and a financial network host computer system. The financial network host computer system includes a network adapter coupled with the financial network and a processor. The system may receive a transaction card number for authentication of a transaction between a cardholder and a merchant using a transaction card. The system may then determine whether an issuing institution associated with the transaction card accepts Internet cardholder authorization of PIN-less transaction card transactions. Whereupon a URL may be sent to the cardholder directing a web browser to a webpage maintained by the issuing institution for authorization of a cardholder for transaction card Internet transaction. If the issuing institution authenticates the transaction, the system may receive authorization from the issuing institution for use of the transaction card for Internet transaction. The authorization may be routed to the system from the merchant or may be sent to the system and then sent to the merchant.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components.

FIG. 1 illustrates a communication system architecture that may employ embodiments of the present invention.

FIG. 2 illustrates another communication system architecture that may employ embodiments of the present invention.

FIG. 3 illustrates yet another communication system architecture that may employ embodiments of the present invention.

FIG. 4 shows a flowchart illustrating a scheme for enrolling a transaction card for PIN-less transactions according to one embodiment of the invention.

FIG. 5 shows a flowchart illustrating another scheme for enrolling a transaction card for PIN-less transactions according to one embodiment of the invention.

FIG. 6 shows a flowchart illustrating yet another scheme for enrolling a transaction card for PIN-less transactions according to one embodiment of the invention.

FIG. 7 shows a flowchart illustrating a scheme for authorizing a transaction card for PIN-less transactions according to one embodiment of the invention.

FIG. 8 shows a flowchart illustrating a scheme for authorizing a transaction card for PIN-less transactions implementing a security identifier according to one embodiment of the invention.

FIG. 9 shows a flowchart illustrating a scheme for enrolling and authorizing a transaction card for PIN-less transactions implementing a PC signature according to one embodiment of the invention.

FIG. 10 shows a flowchart illustrating a scheme for authorizing a transaction card for PIN-less transactions through the issuing bank's webpage according to one embodiment of the invention.

FIG. 11 shows a flowchart illustrating a scheme for authorizing a transaction card for PIN-less transactions through either the issuing bank's webpage or by implementing a security identifier according to one embodiment of the invention.

FIG. 12 shows another flowchart illustrating a scheme for authorizing a transaction card for PIN-less transactions through either the issuing bank's webpage or by implementing a security identifier according to one embodiment of the invention.

FIG. 13 shows a flowchart illustrating a scheme for enrolling and authorizing a transaction card for PIN-less transactions through either the issuing bank's webpage or by implementing a security identifier according to one embodiment of the invention.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention as set forth in the appended claims.

Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner.

It should also be appreciated that the following systems, methods, and software may be a component of a larger system, wherein other procedures may take precedence over or otherwise modify their application. Also, a number of steps may be required before, after, or concurrently with the following systems, methods, or software.

### I. Overview

Systems, methods, and software are described for enrolling and authenticating a cardholder for use of a transaction card without entry of a PIN. Embodiments of the invention rely on and trust enrollment and authentication schemes established, maintained and performed at the financial. In general, embodiments of the invention provide for systems and methods for authenticating a PIN enabled account through a system other than a financial network host computer system, while authorizing payment through the financial network host computer system.

A PIN can be a number, a series of numbers, letters, characters, or any combination thereof used as a security instrument to authenticate a cardholder. According to certain embodiments of the invention, a financial network host computer system receives requests for enrolling cardholders for use of a transaction card without a PIN, for example, in Internet transactions. In response to the request the financial network host computer system, may retrieve past transaction card transactions and query the cardholder to select an actual transaction card transaction from a list including at least one bogus transaction card transaction as well as an actual transaction card transaction. If the cardholder is successful, a digital copy of a physical identifier, such as a fingerprint, voiceprint, or PC signature may be sent to the financial network host computer system. Additionally, the cardholder may be asked to create one or more identifiers that can be used during authentication to validate the cardholder. The financial network host computer system may then hash and store the physical identifier.

Other embodiments of the invention relate to authenticating a cardholder for PIN-less Internet transactions with a transaction card. In one such embodiment, the cardholder agrees to a PIN-less transaction with a merchant. The merchant, accordingly, may request authentication for the transaction by forwarding details to the financial network host computer system. The financial network host computer system may retrieve any hashed physical identifiers associated with the transaction card. If physical identifiers have been enrolled, the system may then request identification of the cardholder. The financial network host computer system receives a digital physical identifier, hashes the physical identifier and compares this hashed physical identifier with the stored hashed physical identifier. If they match, the financial network host computer system may authenticate the transaction card for PIN-less transactions and the system may proceed with the transaction; if they don't match then authentication fails. Authorization or approval of a cardholder for a PIN-less transaction may include a series of procedures and/or protocols. In some embodiments a transaction may not be complete upon approval or authorization. Authorization and/or verification of funds and/or identity may still be required, as well as other steps.

In another embodiment the cardholder agrees to a PIN-less transaction with a merchant. The merchant, accordingly, requests authentication for the transaction by forwarding details to a financial network host computer system. In such embodiments, the system determines whether the transaction card's issuing institution participates in authenticating PIN-less transaction card transactions. If so, the financial network host computer system sends to the cardholder an Internet link to the issuing institutions webpage for authentication. The issuing institution then authenticates the cardholder for Internet PIN-less transactions, and the transaction may proceed.

### II. System Architecture

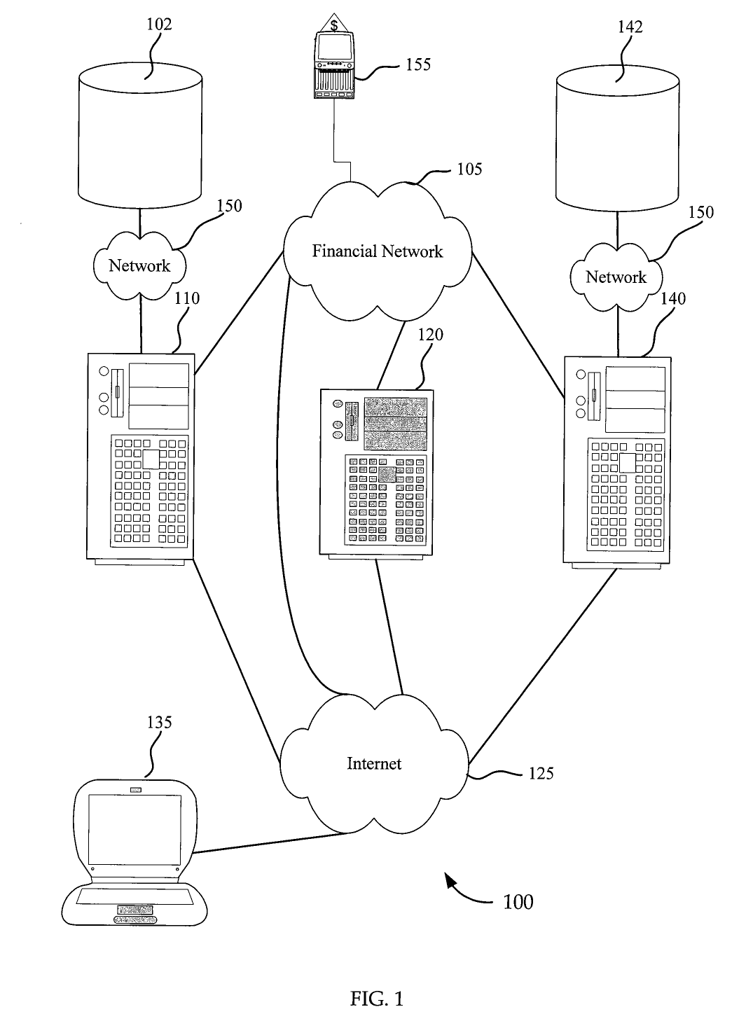

FIG. 1 illustrates an example of a communications system 100 within which various embodiments of the present invention may be implemented. The system components may be directly connected, or may be connected via a network 150 which may be any combination of the following: the Internet, an IP network, an intranet, a wide-area network (“WAN”), a local-area network (“LAN”), a virtual private network, the Public Switched Telephone Network (“PSTN”), a financial network, a mobile phone network, or any other type of network supporting data communication between devices described herein, in different embodiments. The financial network may comprise a debit network, an ATM network, a credit card network or any other financial network. A network 150 may include both wired and wireless connections, including optical links. Many other examples are possible and apparent to those skilled in the art in light of this disclosure. In the discussion that follows, a network 150 may or may not be noted specifically. If no specific means of connection is noted, it may be assumed that the link, communication or other connection between devices may be via a network 115.

2. Financial Network

The financial network 115 in its simplest form provides communication with a financial network host computer system 110, merchants 120, financial institutions 140, ATMs 155, etc. Devices on the financial network 105 may communicate with other devices through the network, through a modem, a network interface card, or other wireless card connecting the ATM 155 to a phone line, a four-wire dedicated phone line, a dedicated data line, a wireless network, an optical network, or other communication medium known in the art. A financial institution 140 may also communicate with the financial network host computer system 110. The financial institution 140 may include, for example, one or more server computers, workstations, web servers, or other suitable computing devices. The financial institution 140 may be fully located within a single facility or distributed geographically, in which case a financial network 115, the Internet 125, or other network 150, as described above, may be used to integrate different components. The financial institution 140 may, for example, communicate transaction information, account numbers, authentication, and PINs through the financial network 115, the Internet 125, or other networks to the financial network host computer system 110. The financial institution 140 may also communicate with a merchant 120 and/or the cardholder 135 through the financial network 115, the Internet 125, or other networks to the financial network host computer system 110.

By way of example, the financial network 125 may comprise a network such as the NYCE® network, the Pulse® network, the STAR® network, and the like. The financial network 105, in some embodiments, may also be coupled with a merchant 120. A variety of other combinations is possible and will be apparent to those skilled in the art.

The cardholder 135 may access the financial network through any Internet accessible hardware. For example, the cardholder may access the network using a PC, a mobile computer, a telephone, a smart phone, mobile phone or any other network accessible device.

3. Financial Network Host Computer System and Database

The financial network host computer system 110 and database 112 may be directly connected or coupled through a network 150. The financial network host computer system 110 may include, for example, one or more server computers, workstations, web servers, or other suitable computing devices. The financial network host computer system 110 may be fully located within a single facility or distributed geographically, in which case a financial network 115, the Internet 125, or other Network 150, as described above, may be used to integrate different components. A financial network host computer system 110 may comprise any computing device configured to process, manage, complete, analyze, or otherwise address a request to authenticate a cardholder, a request to authorize a PIN-less transaction card transaction, a request to notify financial institutions of compromised accounts, request authentication for a cardholder using a transaction card from a financial institution, receive physical identifiers from the cardholder, retrieve and compare physical identifiers though a network or directly, as well as other similar tasks.

Application software running on the financial network host computer system 110 may receive a request to enroll a cardholder 135 for PIN-less transaction card transactions, query the database 112 to identify whether a cardholder is enrolled for PIN-less transaction card Internet transactions. The system may also receive authentication requests from merchants 120, send URLs to the cardholder 135, receive authentication from financial institutions 140, and transmit authentications results to the merchant 120 and/or the cardholder 135. Such software may also include the functionality to receive a request to authorize a transaction, and may authorize the transaction as appropriate. The software may also include functionality to create a cryptographic hash of physical identifiers and compare a stored hash with a new hash. The software may also include functionality to create bogus transaction card transaction records and list such bogus records with authentic records for presentation to the cardholder.

The financial network host computer system 110 may receive communications through the internet 125 from the cardholder 135 for enrollment for with a transaction card for PIN-less transactions. The request may also include a digital physical identifier. The request may also contain the transaction card number, and the Internet IP address of the cardholder, as well as other transaction related data. The physical identifier may comprise any biometric identifiers such as, for example, fingerprints, retinal scans, DNA prints, and voiceprints as well as computer fingerprints and/or scans. Other physical identifiers may include id cards.

The financial network host computer system 110 is coupled with a database 112. The database 112 may be coupled to the financial network host computer system 110 either through a network 150 or directly. The database 112 may maintain past transaction card transaction records, hashes of physical identifiers and information regarding whether financial institutions issuing transaction cards participate in online Internet authentication of PIN-less transaction card transactions. The database 112 may comprise one or more different databases, which may be located within a single facility or distributed geographically, in which case a Network 150, as described above, may be used to integrate different components. According to different embodiments of the invention, the database 112 may include any number of tables and sets of tables. One or more of the databases may be a relational database. The database 112 may be incorporated within the financial network host computer system 110 (e.g., within its storage media), or may be a part of a separate system. The financial network host computer system 110 may, therefore, comprise the database 112. The database 112 may be organized in any manner different than described above to provide the functionality called for by the various embodiments, as known by those skilled in the art.

The financial network host computer system 110 may also be connected with a merchant 120. While a merchant 120 is shown in the figures and used throughout the specification to describe embodiments of the invention, the invention is not limited to transactions solely with merchants. Embodiments of the invention may extend to payments to companies, such as, for example, payments to utility companies, credit card companies, mortgage companies, loans servicing companies, landlords, auto brokers, etc as well as transactions with individuals. Furthermore, embodiments of the invention are described in regard to transactions, however, the invention is not limited thereby and extends to all money transfers, micro transactions, tap and go transactions, all payment schemes, all purchases, etc. For example, parents may use embodiments of the invention to transfer money from a personal account to a child's account using embodiments of the invention. As another example a cardholder may make lease payments to an auto broker using embodiments of the invention. As another example a small business may make rent payments to a landlord using embodiments of the invention. As another example a business may make pay for services by transferring money from the business account to the service provider account using embodiments of the invention. As another example a person may also transfer money from a bank account to a credit card account.

The merchant may include a computer system comprising servers, web servers, personal computers, or the like. The connection may occur over the financial network 115, the Internet 125 or another network 150. The merchant server 120 may request authentication for PIN-less transaction card transaction from the financial network host computer system 110. The request may include, for example, transaction information such as, merchant code, merchant address, price of transaction, authentication amount, cardholder information including name, address, and/or transaction card number. The merchant server 120 may also receive a physical identifier from the cardholder 135 and pass it along to the financial network host computer system 110. The cardholder may also request a transaction using other accounts such as a credit card, a checking account, a savings account, other bank account, or a stored-value account. The merchant server 120 may also be in communication with the financial institution 140 server in some embodiments of the invention.

The financial network host computer system 110 may also be connected to a financial institution 140. The financial institution may comprise a bank, credit union, credit card company, gift card issuer, stored value account manager, etc. Moreover, the financial institution 140 may include one or more server computers, workstations, web servers, or other suitable computing devices. The financial institution 140 may be fully located within a single facility or distributed geographically, in which case a financial network 115, the Internet 125, or other network 150, as described above, may be used to integrate different components. The financial network host computer system 110 may communicate with the financial institution 140 for authentication of a transaction card for Internet transactions. The financial network host computer system 110 may also send a link to the cardholder 135 directing the cardholder to the financial institution 140 for authentication through the internet 125. The financial institution 140 may send an authentication for a transaction directly to the financial network host computer system 110, or the financial institution 140 may send authentication directly to the merchant 120. The authentication may include digitally signing an authentication request.

The financial institution 140 may also include a database 142. Furthermore, the financial institution 140 may have software that facilitates the authentication of cardholders for transaction card transactions when the cardholder logs onto the financial institution webpage hosted by the financial institution 140. The authentication process may require a cardholder to present known information, for example, a PIN, a password, a userID, etc. Moreover, authentication may require the cardholder to properly respond to knowledge-based questions, such as, for example, questions like: “what is your pet's name?” “what is your mother's maiden name?” or “what city were you born in?”

### III. Other Exemplary Architectures

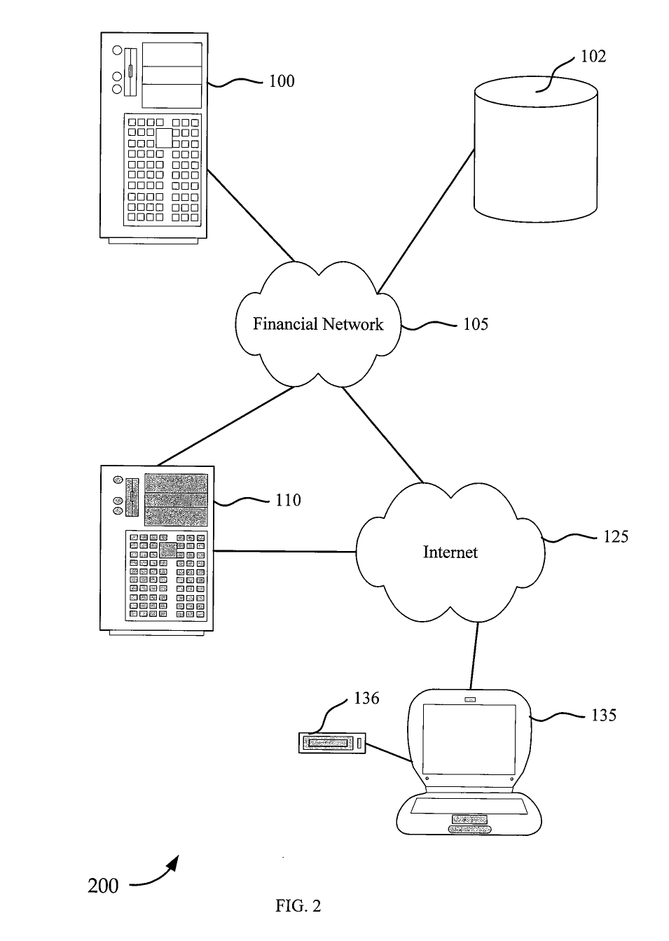

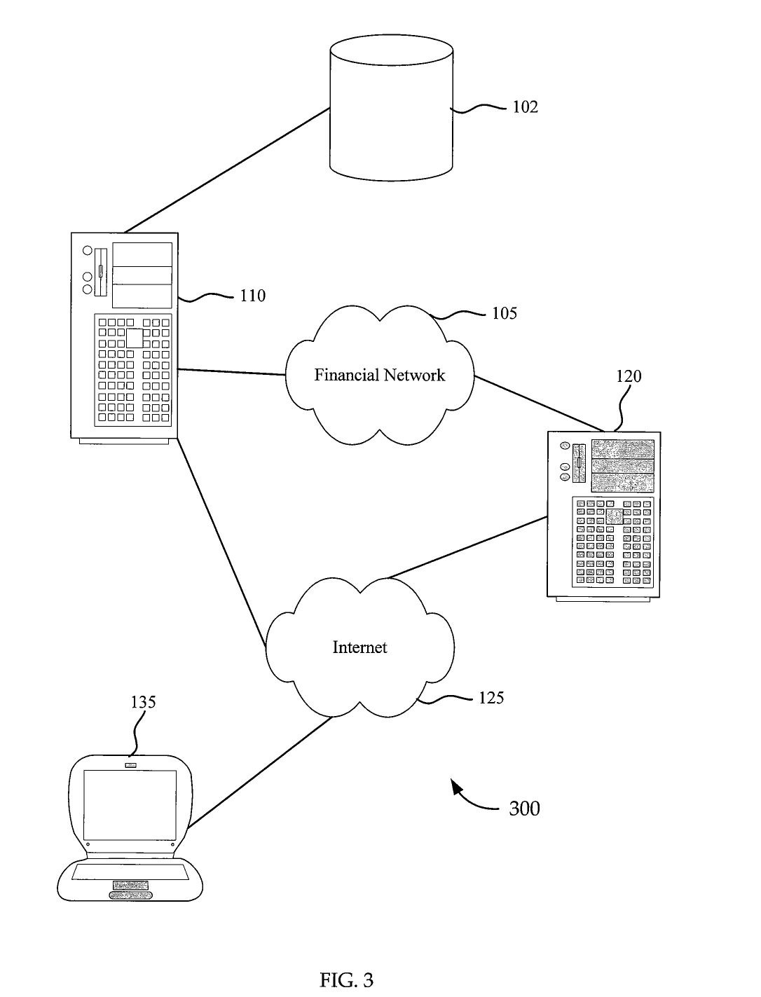

FIGS. 2 and 3 show two exemplary architectures for embodiments of the invention. FIG. 2 shows the cardholder's computer 135 including biometric reading device 136, such as a retinal scanner, a fingerprint reader, DNA scanner or the like. The cardholder's computer is connected to the internet 125. Through the internet 125, the cardholder's computer may be in communication with Merchant server 120 and the financial network 115. The financial network 115 in this architecture, provides communication to the financial network host computer system 110 and a database 112.

FIG. 3 shows another architecture. In this arrangement the financial network host computer system 110, merchant server 120 and the cardholder's computer 135 are all in communication with each other via the Internet 125. The Merchant server 120 and the financial network host computer system 110 are also in communication through the financial network 105. Furthermore, this architecture shows the database 112 directly coupled with the financial network host computer system 110.

### IV. Exemplary Enrollment Embodiments

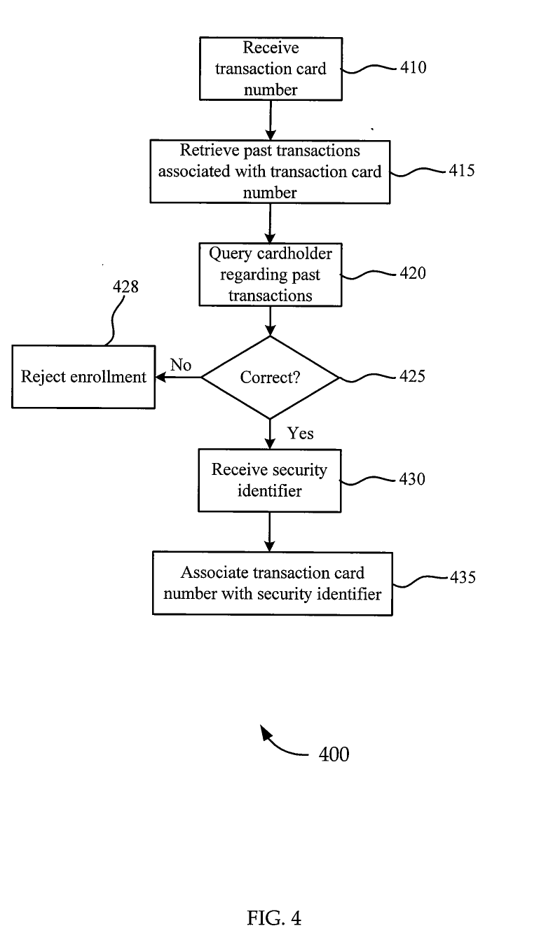

FIG. 4 sets forth an exemplary embodiment 400 of the invention, illustrating an example of a method for enrolling a cardholder for use of a transaction card for PIN-less Internet transactions. At block 410 the financial network host computer system 110 receives a transaction card number for use in an online transaction. The transaction card may be a debit card, ATM card, gift card or other stored value card. The transaction card may require a PIN to access the funds at block 415. The financial network host computer system 110 retrieves past transaction card transactions associated with the transaction card. The financial network host computer system 110 may retrieve these past transactions from a database 112. The system may then query the cardholder regarding past transaction card transactions to confirm the identity of the cardholder. These queries may include any kind of question that requires the cardholder to know the past transaction history of the transaction card. Preferably, the questions are in regard to transactions that required the use of a PIN or other security measure. If the cardholder incorrectly responds at block 425 to the query the financial network host computer system 110 rejects enrollment of the cardholder for use of the transaction card 428. If the cardholder correctly responds to the query at block 425, then the financial network host computer system 110 requests and receives a security identifier or physical identifier 430 from the cardholder. At block 435 the financial network host computer system 110 associates the security identifier with the transaction card number and stores the value, for example, in the database 112.

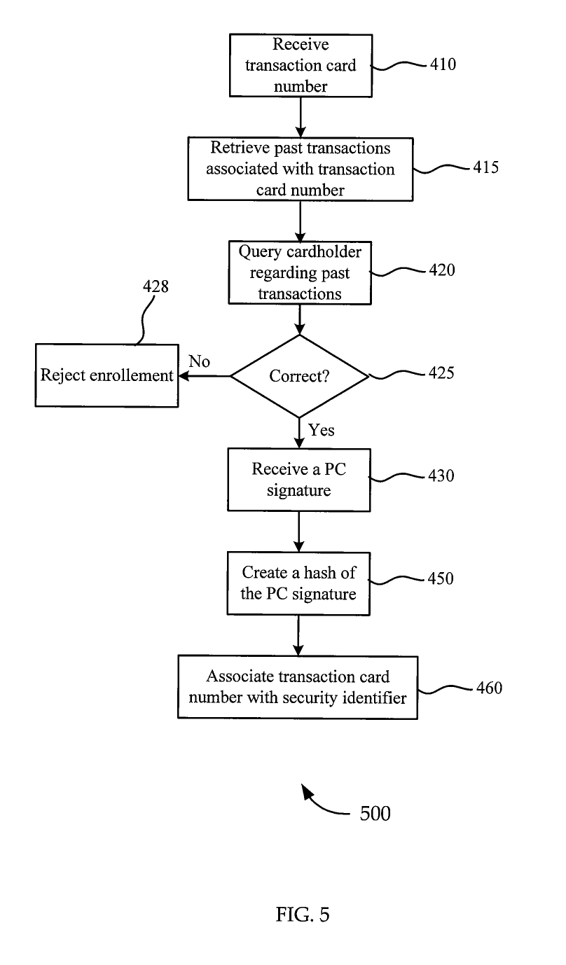

FIG. 5 sets forth a exemplary method that is similar to that illustrated in FIG. 4. Steps 410, 415, 420, 425 and 428 are the same as those shown in FIG. 4. In FIG. 5 the financial network host computer system 110 receives a PC signature as the security identifier fingerprint from the cardholder's computer 135 in block 430. A PC signature is digital characterization of a computer system. Like a human fingerprint, each PC signature is unique to the computer system. PC signatures may be recorded locally via software or through a hardware device. Recording the PC signature of the cardholder's computer 135 may be initiated by the cardholder at the request of the financial network host computer system 110 and then sent to the financial network host computer system 110 through a network 150. The PC signature may be also be recorded remotely by the financial network host computer system 110. Once the PC signature is received, a hash of the PC signature 450 is created and stored with the transaction card number 460. In this embodiment, the PC signature uniquely correlates use of the transaction card for PIN-less transaction card transaction to the cardholder's computer 135.

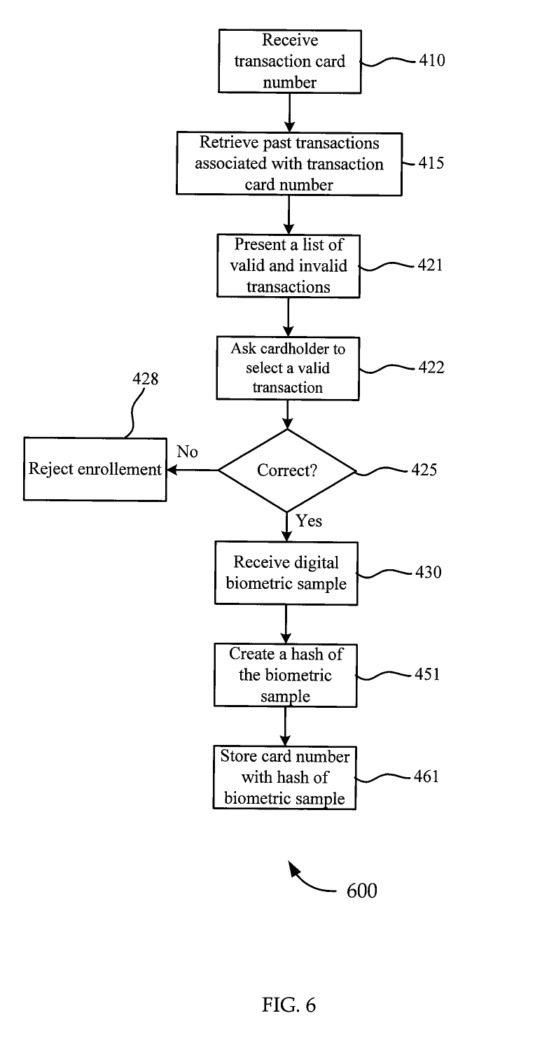

FIG. 6 sets forth another exemplary method similar to those shown in FIGS. 4 and 5. Steps 410, 415, 420, 425 and 428 are the same as those shown in FIGS. 4 and 5. Here, however, the cardholder is enrolled for PIN-less transaction card transactions using a biometric sample from the cardholder. The biometric sample may be digitized at the cardholder's computer 135 by a biometric reader 136. A digital sample may be sent to the financial network host computer system 110 from the cardholder's computer 135 over a network 150 such as the Internet 125. Once the digital sample is received at the financial network host computer system 110, a hash of the biometric sample 451 may be created and stored in association with the transaction card number 461. The biometric sample uniquely correlates use of the transaction card for PIN-less transaction card transaction to the cardholder with the biometric features.

The embodiments represented in the flow charts shown in FIGS. 4-6 show systems using various security identifiers with PIN-less transactions. Multiple cardholder computers 135 may be connected to the financial network host computer system 110 over a network 150 such as the Internet 125. The various computers may use different security identifiers to associate a cardholder or computer with a transaction card. The financial network host computer system 110 may receive, hash and store a plurality of different types of security identifiers. The financial network host computer system 110 may require specifications as to the size and format of the security identifier, but the means for collecting the actual identifier may vary across a plurality of cardholder computer 135.

For example, one cardholder may use a fingerprint as a security identifier for PIN-less transaction card transactions. Another cardholder may use a PC signature. Another cardholder may use keystroke dynamics as a security identifier that uniquely ties the cardholder to the transaction card for PIN-less ATM transactions over the Internet. Any security identifier may be used without deviating from the spirit and scope of the invention.

### V. Exemplary Authentication with Physical Identifiers Embodiments

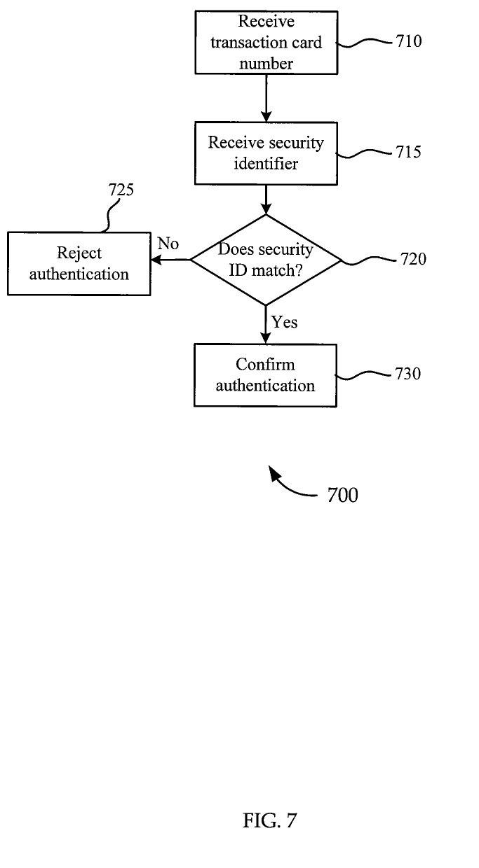

FIG. 7 shows a flowchart 700 illustrating an embodiment authorizing PIN-less transaction card transactions over the Internet. In this embodiment the financial network host computer system 110 receives a transaction card number for authorization 710 as well as a security identifier 715, such as a biometric sample or a PC signature or the like. At block 720, the system determines whether the security identifier matches a security identifier associated with the transaction card. If not, authentication is rejected 725. If there is a match, authentication is confirmed 730 and the transaction moves along.

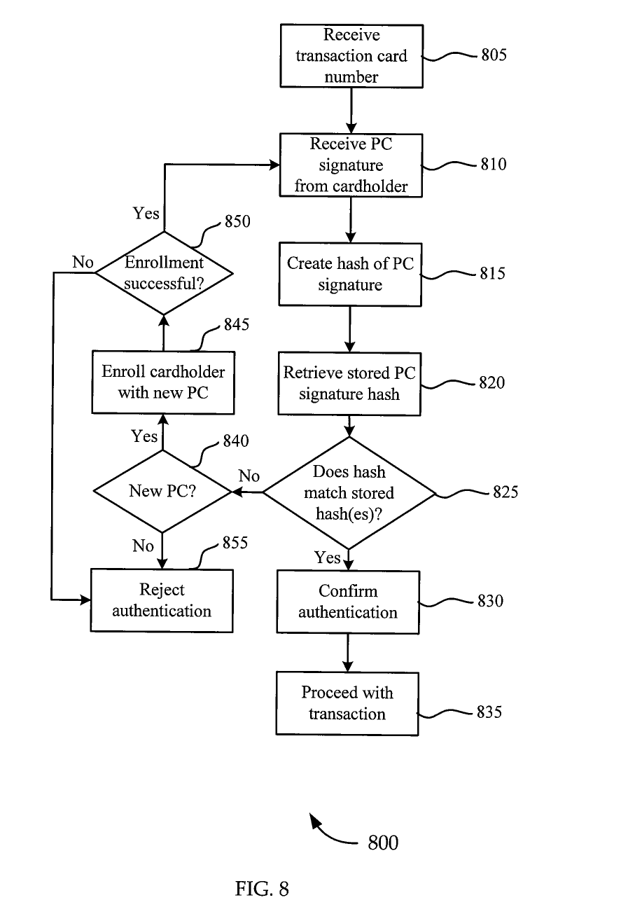

FIG. 8 shows a flowchart 800 illustrating another authorization scheme. At block 805 a transaction card number is received from a vendor requesting authorization of a transaction card for a PIN-less transaction between the vendor and a cardholder. The system receives a PC signature from the cardholder 810. The PC signature may be sent by the cardholder in response to request from either the vendor or the system. Furthermore, the system may remotely retrieve a PC signature over the network 150. The system may then create a hash of the PC signature at block 815. A stored PC signature that is associated with the transaction card number is retrieved at block 820. A comparison between the stored and receive PC signature hashes is made at block 825. If the comparison fails, the cardholder may be queried to determine if they are using a new computer or whether they have made significant changes to the hardware, software or operating system on the computer at block 840. If not, authorization is rejected 855. If so, the cardholder is allowed to re-enroll 845. If enrollment is successful 850, the system may then restart and begin authorization anew. If enrollment is not successful at block 850, authorization is rejected 855. Returning back to block 825, if the hashes match, then authorization is confirmed 830, and the transaction may proceed 835.

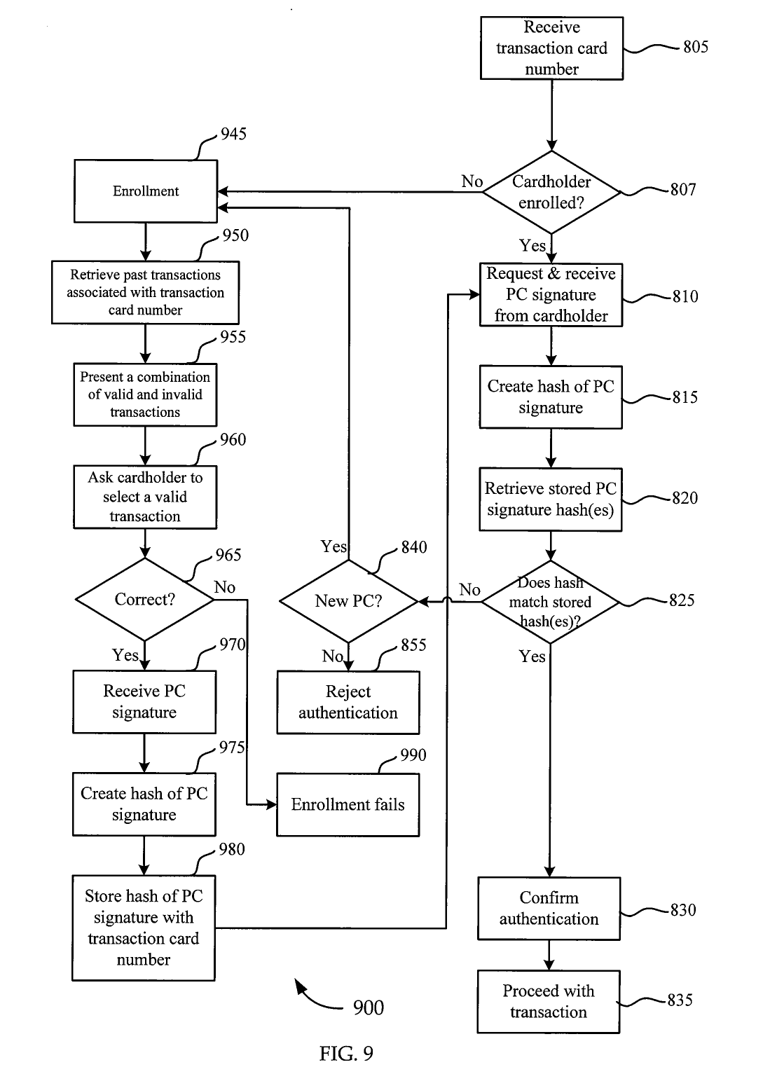

The flowchart 900 shown in FIG. 9 expands the flowchart of FIG. 8 according to anther embodiment of the invention. A transaction card number is received 805 and a determination is made whether the transaction card has previously enrolled in PIN-less transaction card transactions 807. If the transaction card has not been enrolled, the system proceeds to block 945 for enrollment. If the transaction card has previously been enrolled then the process proceeds as shown in the flowchart 800 in FIG. 8 along blocks 810, 815, 820, 825, 830, 835, 840 and 855. Enrollment begins at block 945. At block 950, the system retrieves past transactions associated with the transaction card number. A combination of valid and invalid transactions are presented to the cardholder at block 955 and the cardholder is asked to select a valid transaction from the list 960. Any number of valid and invalid transaction may be presented in the list. For example, two valid transactions and four invalid transactions may be presented and the cardholder may be asked to select one or both valid transactions. Furthermore, one valid transaction may be presented in a list with multiple invalid transactions. The list may comprise the date, merchant name, and amount of the transaction, as well as any other transaction identifying information.

If the cardholder is unsuccessful in selecting a transaction at block 965, enrollment of the cardholder fails 990. If the cardholder is successful at block 965, a PC signature of the cardholder's computer is received 970, either directly or indirectly from the cardholder's computer. A hash of the PC signature is made 975 and stored in association with the transaction card number 980 without requiring further authentication. Once enrollment is complete, the cardholder is returned to block 810 for authentication of the transaction. Other embodiments may authenticate the transaction after successful enrollment at block 980. Other embodiments may require the system to return to block 805 for authentication.

### VI. Exemplary Authentication Through Financial Institution Embodiments

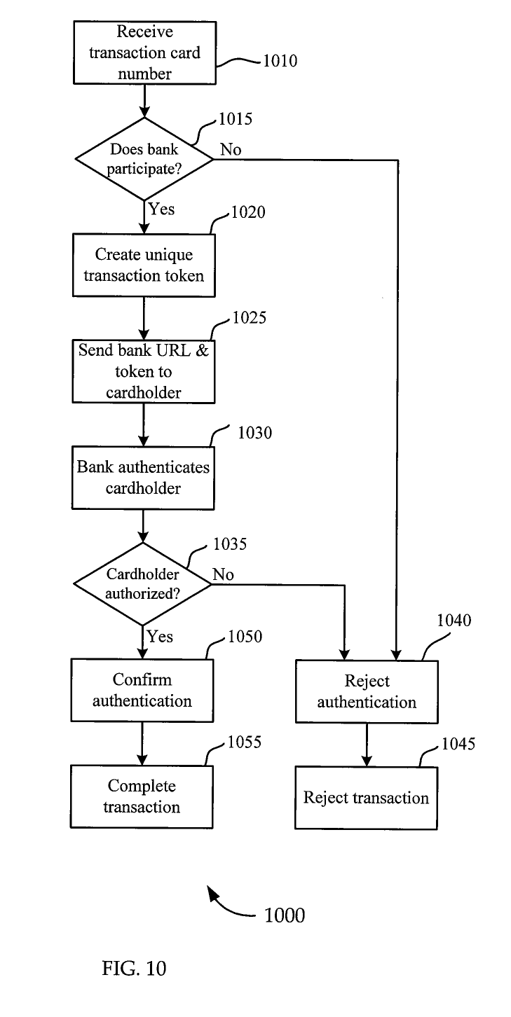

Another embodiment of the present invention is the authorization of PIN-less transaction card transactions through an issuing institution 140, such as a bank or other financial institution, as depicted in the flow chart 1000 in FIG. 10. A transaction card number is received by the financial network host computer system 110 at block 1010. The financial network host computer system 110 determines whether the issuing intuition 140 participates in PIN-less ATM authentication 1015. If not, the authentication is rejected 1040 and the transaction is rejected 1045. If the issuing institution does participate, the financial network host computer system 110 may create a unique transaction token that properly identifies the transaction 1020 and may include transaction details, such as, transaction card number, transaction card holder name, transaction amount, merchant name and location or other transaction identifying information The financial network host computer system 110 then sends a URL to the cardholder that includes and/or refers to the token at block 125. The URL may include the Internet address of the issuing institutions webpage for PIN-less transaction card Internet transaction authentication. The webpage is preferably secure. This page may also be integrated with other online services. Authorization of the ATM for the transaction depends on the issuing institution 1030. Various institutions may have any of a number of specifications for authenticating a transaction. For example, the issuing institution may require the cardholder to enter their transaction card number and PIN for authentication. The issuing institution may also query the cardholder about personal information, require a password, and/or query the cardholder about past transactions. Whatever the methodology used by the issuing institution, this embodiment of the invention will keep PINs secure by limiting communication of PINs between the issuing institution and the cardholder. At block 1035 the bank may deny authentication or authorize transaction 1030. After authorization the transaction may be completed between the merchant, cardholder and financial network host computer system. The bank may also send a digital signature to the merchant and/or the financial network host computer system permitting the PIN-less transaction card transaction.

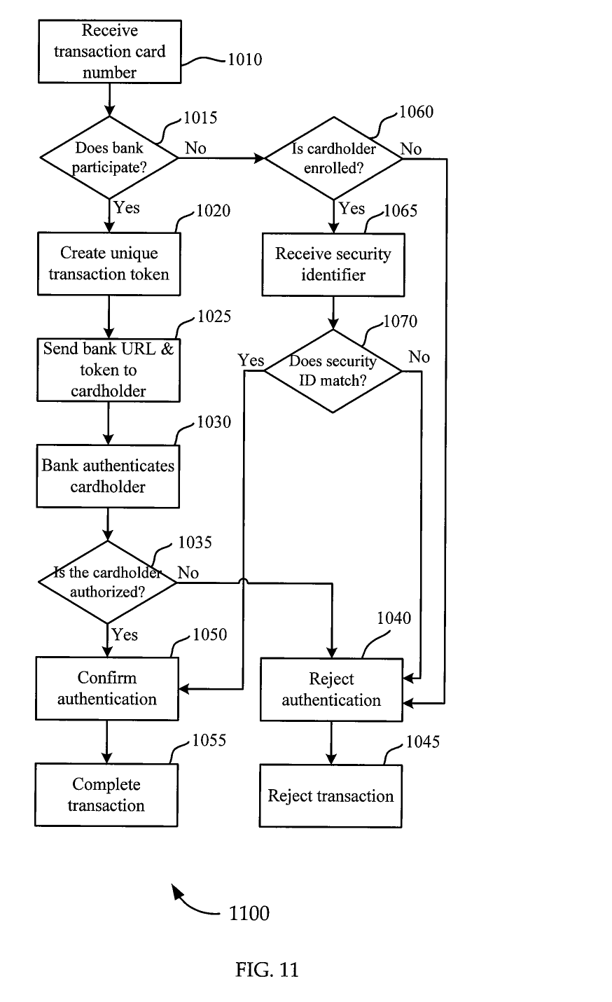

Another embodiment of the present invention is shown in the flowchart 1100 depicted in FIG. 11. This embodiment is similar to that shown in FIG. 10, however, rather than rejecting authentication 1040 if the bank does not participate, the system may determine if the cardholder is enrolled for PIN-less transaction card transaction with a security identifier at block 1060. If the cardholder is not enrolled, then authentication fails 1040. If they are enrolled, then the system will receive a security identifier 1065 and determine, at block 1070, if the security identifier matches the security identifier used to enroll in the system. If there is a match, authentication may be confirmed 1050 and the transaction may be completed 1055. If not, the authentication 1040 and transaction 1045 will be rejected.

### VII. Exemplary Combined Enrollment and Authentication Embodiments

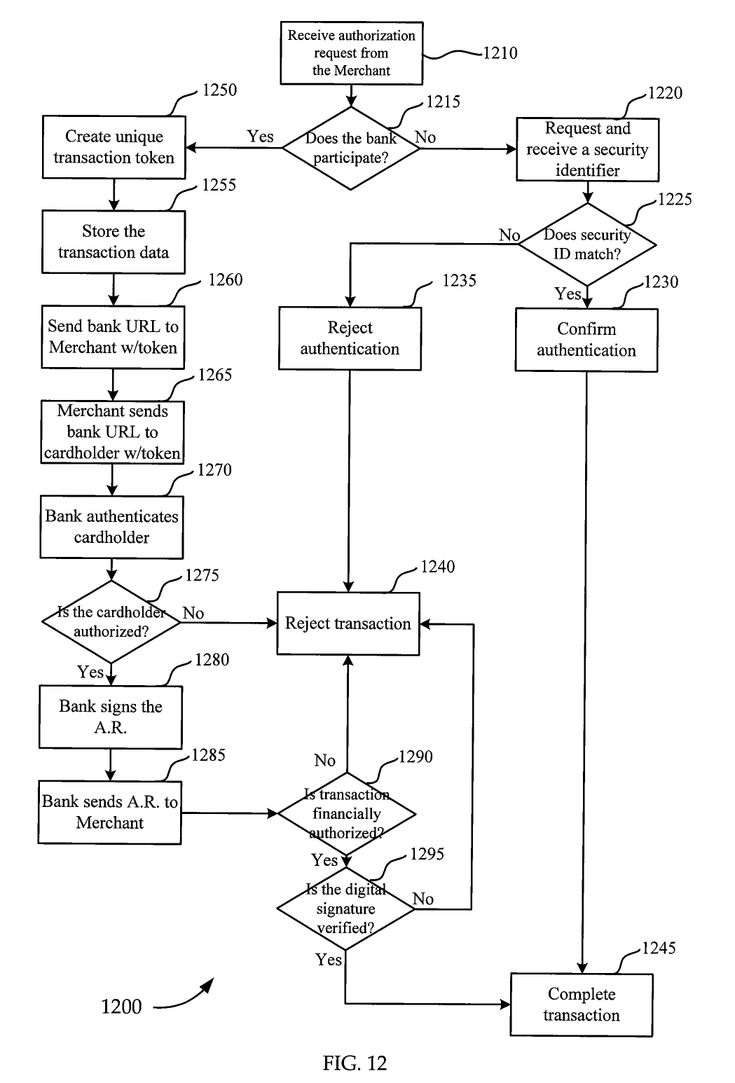

FIG. 12 illustrates a flowchart 1200 of another embodiment of the present invention. In the first block 1210 the system receives an authorization request four a merchant. The authorization request may include transaction data including the transaction card number, cardholder information, merchant information and transaction information. The system then determines whether the cardholder's bank participates in PIN-less transaction card transactions in block 1215. While a bank is used to describe this embodiment, the invention is not limited to banks; other financial institutions may be used. If the cardholder's bank participates, the system may create a unique transaction token that identifies the transaction and may contain transaction information at block 1250. At block 1255 the authorization request is stored in the system. A URL pointing to the bank's webpage and that may include the token is sent to the merchant at block 1260. The merchant may then forward the token to the cardholder 1265. Whereupon the bank's webpage related to the URL is opened either automatically or by initiation by the cardholder. The cardholder logs in and completes any authenticating steps required by the bank. The bank may require any number of authenticating schemes of methods including, but not limited to, passwords, querying for identifying information, biometrics, PINs, PC signatures, and/or other security identifiers. The bank is free to authenticate the cardholder based on any authentication scheme according to the banks specification. If the bank denies authentication at block 1275, the transaction is rejected 1240. If the bank authorizes the transaction at 1275 the bank digitally signs the authentication request 1280 and sends it to the merchant 1285. The bank may include the token with the authorization request and/or may individually send the token back to the system. The system then authorizes the transaction by verifying funds at block 1290, and further verifies the digital signature from the bank at block 1295. If either step in block 1290 or 1295 is denied then the transaction is rejected 1240.

Returning to block 1215, if the bank does not participate, the system requests and receives a security identifier from the cardholder at block 1220. The system then determines if the security identifier matches stored identifiers associated with the transaction card at block 1225. If there is no match, the authentication is rejected at 1235 and the transaction is rejected at 1240. If the security identifier matches at block 1225, authentication is confirmed 1230 and the transaction may be completed 1245.

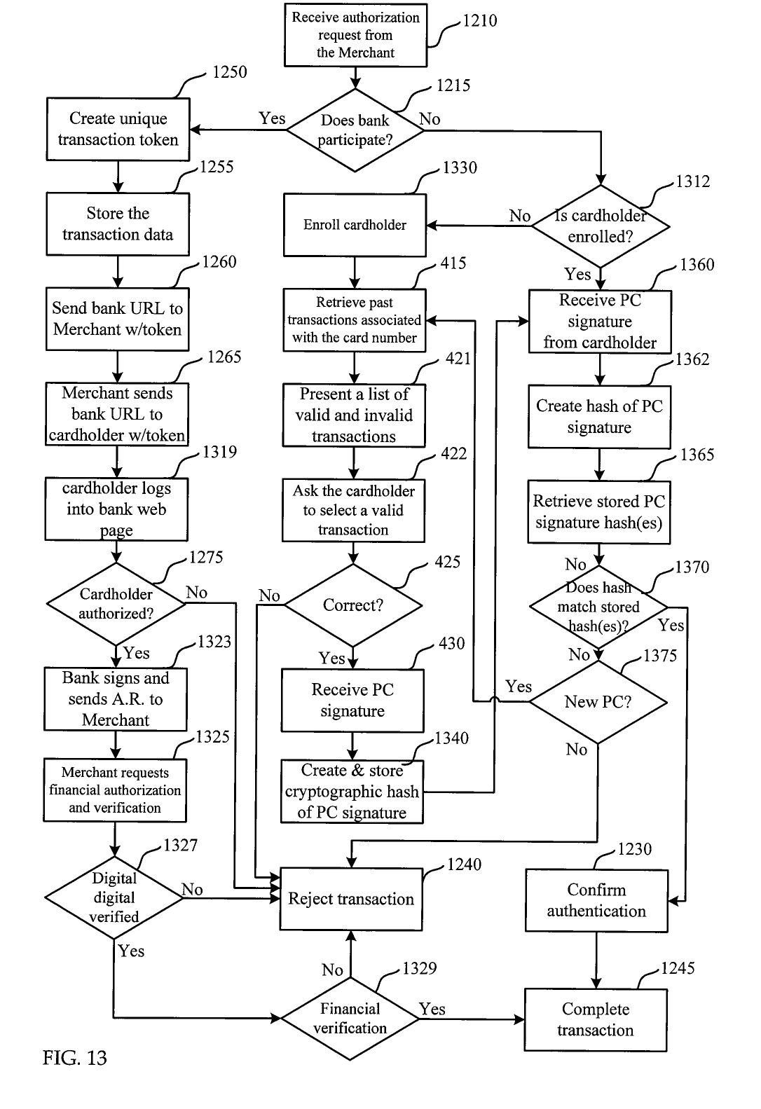

FIG. 13 shows a flow chart incorporating an embodiment of the present invention incorporating enrollment and two authentication schemes into one system. Once a cardholder and merchant reach an agreement about a transaction and the cardholder elects to pay for with a transaction card, the merchant may send and authorization request to the financial network host computer system 110. The authorization request is received by the financial network host computer system 110 along with any other transaction data at block 1210. The financial network host computer system 110 determines if the bank associated with the transaction card identified in the authorization request is enrolled for PIN-less transaction card transactions. If the cardholder's bank is enrolled for PIN-less transaction card transactions, then the system moves to block 1250 where the system may create a unique transaction token that identifies the transaction and may contain transaction information including the authorization request. At block 1255 the authorization request and/or transaction data is stored in the system. A URL pointing to the bank's webpage and that may include the token is sent to the merchant at block 1260. The merchant forwards the token to the cardholder 1265. Whereupon the bank's webpage related to the URL is opened either automatically or by initiation by the cardholder. The cardholder logs in and completes any authenticating steps required by the bank 1319. The bank may require any number of authenticating schemes of methods including, but not limited to, passwords, querying for identifying information, biometrics, PINs, PC signatures, and/or other security identifiers.

If the cardholder is authorized by the bank and has passed the requirements imposed by the bank, the bank signs and sends the authorization request to the merchant at block 1323 signifying approval of the PIN-less transaction card transaction. Thereafter, at block 1325, the merchant requests financial authorization and verification at block 1325. If the transaction is not financially authorized 1329, the transaction is rejected 1240. A transaction is financially authorized if there are sufficient funds in the account associated with the transaction card. This authorization may occur at the financial network host computer system 110 or the bank system 140. If the transaction is not financially authorized, then the transaction is rejected 1240. The financial network host computer system 110 will then verify the digital signature supplied by the bank at block 1327. If the digital signature cannot be verified, the transaction is rejected 1240, otherwise authorization is successful and the transaction may be completed 1246.

Returning to block 1215, if the cardholder's bank does not participate, the system moves to block 1312 and determines whether the cardholder has previously enrolled with a physical security identifier. If the cardholder is not enrolled, enrollment begins at block 1330. If the cardholder is enrolled, the system receives a security identifier, in this case a PC signature, at block 1360. The PC signature may be sent by the cardholder following a request from the system or it may be remotely received by the system. The system creates a hash of the PC signature at 1362, retrieves stored hashes 1365 and compares the two at 1370. If the two match, authentication is confirmed at block 1230 and the transaction is verified 1245. In other embodiments, prior to completing the transaction at block 1245, further authorization and verification may be performed, such as at block 1329.

If the stored hash and the recently received hash do not match at block 1370, the system may query the cardholder at block 1375 to determine if they are using a new computer. If not, the transaction is rejected. If they are using a new computer the cardholder may be allowed to enroll the new computer at block 415. Steps 415, 421, 422, 425 and 430 are similar to those shown in FIGS. 5 and 6. In block 415 the system retrieves past transactions associated with the transaction card. The system then presents the cardholder with a combination of actual transaction card transactions and bogus transaction card transactions at block 421. The actual transaction card transactions, in one embodiment, are PIN secured transaction card transactions. The system asks the cardholder to select the actual transaction at block 422; if they select a bogus transaction 425 the enrollment and the transaction fail 1240. If the cardholder is successful at block 425, the system receives a PC signature at block 430 whereupon the fingerprint is hashed and stored in block 1340. After enrollment, the system returns to block 1360.

In some embodiments of the invention described above, the system creates a hash of a physical identifier as shown in block 1362. Hashing refers to a computationally efficient function mapping binary strings of arbitrary length to binary strings of some fixed length, often called “hash values.” It thus permits a data string of arbitrary length to be mapped to a smaller string in a fashion that makes recovery of the original string difficult. The use of such cryptographic hashing may be desirable to ensure that a physical identifier such as a biometric sample a PC signature or the like is secure. There are numerous hashing functions that are known to those of skill in the art and that may be used, including, for example Snefru, N-Hash, MD4, MD5, MD2, PANAMA, any of the Secure Hash Algorithms (“SHA”), RIPE-MD, Tiger, VEST, Whirlpool, and HAVAL. Many of these cryptographic hashing techniques and others are described in further detail in Bruce Schneier, Applied Cryptoraphy (John Wiley & Sons 1996), 2d ed., Chap. 18 (“Schneier II”), the entire disclosure of which is herein incorporated by reference in its entirety for all purposes.

The embodiments of the present invention may be initiated in any number of ways. For example, the cardholder may visit the merchant's web page where the cardholder selects an item to purchase. During the check-out process, the merchant may present the cardholder with a variety of payment schemes that are acceptable to the merchant. One payment scheme may include using a transaction card. If the cardholder selects the transaction card scheme, the proceeds according to the embodiments of the present invention and sends an authorization request to the financial network host computer system 110. In an enrollment embodiment, the cardholder may simply direct a web browser to the appropriate financial network web page where enrollment embodiments may begin. The cardholder may be directed to the financial network from the cardholder's bank, financial institution or the like.

As used throughout this application, a cardholder may be a user, consumer or customer as well as any person using a transaction card or the like in a transaction. The cardholder may use the cardholder's computer as shown in the figures. Embodiments of the invention, while described in relation to Internet transactions are not limited thereby. Other types of PIN-less transaction card transactions may be included. The term “system” used throughout the specification may refer to a debit card network host, a debit card server, a debit card computer system, a credit card network host computer, an ATM network computer system, a financial network host computer system, or the like and may describe processes or methods operating thereon. Moreover, the terms issuing institution, bank, and financial institution each refer to an entity that issues ATM like cards with access secured by a PIN. These entities also have access to and participate across a financial network or networks. The description and claims are not meant to be limited by use of the above terms. Rather, these terms are used in an exemplary manner in order to fully enable and describe the embodiments of the invention. Those skilled in the art will recognize various cardholders, transactions, transaction cards, accounts, systems, and/or issuing institutions that may be implemented without deviating from the spirit and scope of the claimed invention.

Furthermore, the term merchant has been used in to describe a third party payment recipient. The embodiments of the invention are not limited to transactions between a cardholder and a merchant, but extend to any transaction between a cardholder and a third party. Merchant may also refer to a third party that manages accounts for the cardholder and a transaction may be between two cardholder accounts.

Furthermore the term transaction card as used throughout the may include but is not limited to ATM cards, credit cards, charge cards, stored value accounts, stored value cards, gift cards, checking accounts, savings accounts, bank accounts, or the like whether or not the transaction card or account is PIN secured or not.

What is claimed is:

1. A system for enrolling a cardholder for use of a transaction card in a PIN-less transactions comprising:
an electronic storage; and
a financial network host computer comprising a processor and a network adapter, and connected with the electronic storage;
wherein the processor comprises:
instructions to receive a request from a cardholder for enrollment in PIN-less transactions associated with a transaction card;
instructions to retrieve past transaction card transactions associated with the transaction card from the electronic storage;
instructions to provide to a cardholder a listing of transaction card transactions, wherein the listing of transaction card transactions comprises at least one true transaction card transaction selected from past transaction card transactions within a predetermined time period and at least one fictitious transaction card transaction;
instructions to query the cardholder to select at least one true transaction card transaction from the listing of at least one true transaction card transaction and at least one fictitious transaction card transaction;
instructions to receive from the cardholder at least one selected transaction, wherein the cardholder selects a transaction from the list of the at least one true transaction card transaction and the at least one fictitious transaction card transaction;
instructions to verify that the at least one selected transaction corresponds to at least one of the true transaction card transactions;
instructions to receive, upon successful verification of the selected transaction, a physical identification sample from the cardholder;
instructions to hash the physical identification sample; and
instructions to store the hash of the physical identification sample in electronic storage.

2. The system of claim 1 wherein the processor further comprises instructions to request a physical identification sample from the cardholder.

3. A system for authenticating a cardholder using a PIN-less transaction card in an Internet transaction between the cardholder and a merchant through a financial network, the system comprising:
a financial network;
a financial network host computer comprising a processor and a network adapter coupled with the financial network; and
an electronic storage coupled with the financial network host computer;
wherein the financial network host computer processor comprises:
instructions to receive a transaction request from a merchant for an Internet transaction between the merchant and a cardholder using a transaction card, wherein the transaction requests comprises a transaction card number;
instructions to confirm that the transaction card is enrolled for use in PIN-less Internet transactions and has at least one stored physical identification hash associated with the transaction card stored in the electronic storage;
instructions to receive a digital physical identification sample from the cardholder;
instructions to hash the physical identification sample into a hash of the physical identification sample;
instructions to retrieve at least one stored physical identification hash associated with the transaction card from electronic storage;
instructions to compare the hash of the physical identification sample with the at least one stored physical identification hash associated with the transaction card; and
instructions to send authorization for the PIN-less transaction card transaction to the merchant if the physical identification sample matches the stored physical identification sample.

4. A system for authenticating a cardholder using a PIN-less transaction card in an Internet transaction between the cardholder and a merchant, the system comprising:
a financial network host computer comprising a processor and a network adapter, wherein the financial network host computer is coupled with a network through the network adapter; and
an electronic storage location coupled with the financial network host computer;
wherein the financial network host computer processor comprises:
instructions to receive a transaction card number for authentication of a transaction between a cardholder and a merchant using a transaction card;
instructions to send a URL to the cardholder, wherein the URL directs a web browser to a webpage maintained by the issuing institution for authorization of cardholders for transaction card Internet transaction;
instructions to receive authorization from the issuing institution for use of the transaction card number for the transactions; and
instructions to send authorization to the merchant for the PIN-less transaction card transaction.

5. The system of claim 4 further comprising instructions to determine whether an issuing institution associated with the transaction card accepts Internet cardholder authorization of PIN-less transaction card transactions.

6. The system of claim 4, wherein the electronic storage is coupled with the financial network host computer through the financial network.

7. The system of claim 4, wherein the electronic storage is directly coupled to the financial network host computer.

8. The system of claim 4, wherein the financial network host computer processor further comprises instructions to create a unique transaction token that identifies the transaction and associates the token with the URL sent to the cardholder.

9. The system of claim 4, wherein the instructions to send the URL to the cardholder further comprises instructions to send the URL to the merchant, wherein the merchant sends the URL to the cardholder.

10. A method for enrolling a cardholder using a PIN-less transaction card in an Internet transaction at a financial network host computer, comprising:
receiving a request for enrollment of a transaction card for PIN-less transaction card transactions over the Internet from the cardholder, wherein the request comprises the transaction card number;
retrieving a plurality of past transaction card transactions associated with the transaction card;
providing, in response to the request for enrollment, a listing of transaction card transactions, wherein the listing of transaction card transaction comprises at least one true transaction card transaction selected randomly from the past transaction card transactions within a predetermined time period and at least one fictitious transaction card transaction;
querying the cardholder to select at least one true transaction card transaction from the listing of the at least one true transaction card transaction and the at least one fictitious transaction card transaction;
receiving from the cardholder at least one selected transaction, wherein the cardholder selects at least one transaction from the list of at least one true transaction card transaction and the at least one fictitious transaction card transaction;
verifying that the at least one selected transaction corresponds to at least one true transaction card transactions;
receiving, upon successful verification of the selected transaction, a physical identification sample from the cardholder;
hashing the physical identification sample, wherein the hashing results in a hash of the physical identification sample; and
storing the hash of the physical identification sample and associating the hash with the transaction card number.

11. The method of claim 10 wherein the method further comprises requesting a physical identification sample from the cardholder.

12. The method of claim 11 wherein the requesting a physical identification sample from the cardholder is sent to the merchant and forwarded to the cardholder.

13. The method of claim 10 wherein the physical identification sample is selected from the group consisting of a PC signature, a biometric sample, key stroke dynamics, a hardware identifier, and a software identifier.

14. A method for authenticating a cardholder using a PIN-less transaction card in an Internet transaction between a cardholder and a merchant through a financial network at a financial network host computer, the method comprising:
receiving a transaction request from the merchant at the financial network host computer, wherein the transaction request is for an Internet transaction between the merchant and the cardholder using a transaction card;
confirming that the transaction card is enrolled for use in PIN-less Internet transactions and that at least one stored physical identification hash associated with the transaction card is stored in an electronic storage location coupled with the financial network host computer;
receiving a digital physical identification sample from the cardholder;
hashing the physical identification sample, wherein the hashing results in a hash of the physical identification sample;
retrieving at least one stored physical identification hash associated with the transaction card from electronic storage;
comparing the hash of the physical identification sample with the at least one stored physical identification hash associated with the transaction card; and
sending, if the physical identification sample matches the stored physical identification sample, a transaction authorization to the merchant.

15. The method of claim 14 wherein the physical identification sample is selected from the group consisting of a PC signature, a biometric sample, a hardware identifier, and a software identifier.

16. A method for authenticating a cardholder using a PIN-less transaction card in a PIN-less financial transactions, the method comprising:
authenticating the cardholder at a financial institution, wherein the cardholder is participating in a financial transaction with a third party, the transaction card is associated with the financial institution, and the authentication approves the cardholder as authorized to use the transaction card in the financial transactions; and
authorizing a transaction at a financial network host computer system, wherein the authorization approves the terms of the financial transaction.

17. A method for authenticating a cardholder using a transaction card in a financial transactions, the method comprising:
receiving a transaction card number at a financial network host computer for authentication of a transaction between the cardholder and the merchant;
determining at the financial network host computer whether an issuing institution associated with the transaction card accepts Internet cardholder authorization of PIN-less transaction card transactions;
creating a unique transaction token, wherein the token identifies the transaction;
sending a URL to the cardholder, wherein the URL directs a web browser to a webpage maintained by and stored on a server of the issuing institution for authorization of cardholders for PIN-less transaction card Internet transactions, wherein the URL includes a reference to the token;
requesting authorization of the transaction card for PIN-less Internet transaction card transactions from the issuing institution upon successful approval of cardholder by the issuing institution; and
authorizing the transaction upon successful authorization of the cardholder from the issuing institution.

18. The method of claim 17, wherein the token comprises an authorization request.

19. The method of claim 17, further comprising:
receiving an authorization request from the merchant for the Internet transaction; and
receiving a signed authorization request upon authorization of the cardholder for Internet transactions with the transaction card by the issuing institution.

20. The method of claim 19 further comprising:
verifying the authenticity of the digital signature received from the issuing institution.

21. The method of claim 19 wherein the merchant receives the signed authorization request from the issuing institution.

22. The method of claim 19 wherein the financial institution receives the signed authorization request from the issuing institution.

23. A system for enrolling and authenticating a cardholder using a PIN-less transaction card in a PIN-less financial transactions comprising:
an electronic storage; and
a financial network host computer comprising a processor and a network adapter, and connected with the transaction card transaction storage module; wherein the processor comprises:
instructions to receive a request from a cardholder for enrollment of a transaction card number for PIN-less Internet transactions;
instructions to retrieve past transaction card transactions associated with the transaction card from the transaction card transaction storage module;
instructions to provide to a cardholder a listing of transaction card transactions, wherein the listing of transaction card transactions comprises at least one true transaction card transaction selected randomly from the past transaction card transactions within a predetermined time period and at least one fictitious transaction card transaction;
instructions to query the cardholder over the Internet to select at least one true transaction card transaction from the listing of at least one true transaction card transaction and at least one fictitious transaction card transaction;
instructions to receive from the cardholder at least one selected transaction, wherein the cardholder selects a transaction from the list of the at least one true transaction card transaction and the at least one fictitious transaction card transaction;
instructions to verify that the at least one selected transaction corresponds to at least one of the true transaction card transactions;
instructions to receive, upon successful verification of the selected transaction, a first physical identification sample from the cardholder;
instructions to hash the physical identification sample creating a first hash;
instructions to store the first hash in electronic storage;
instructions to receive a transaction request from a merchant for an Internet transaction between the merchant and a cardholder using a transaction card, wherein the transaction requests comprises the transaction card number;
instructions to confirm that the transaction card is enrolled for use in PIN-less Internet transactions and has at least one stored physical identification hash associated with the transaction card stored in electronic storage;
instructions to receive a second physical identification sample from the cardholder;
instructions to hash the physical identification sample creating a second hash;
instructions to retrieve the first hash from electronic storage;
instructions to compare the first hash with the second hash; and
instructions to send authorization for the PIN-less transaction card transaction to the merchant if the physical identification sample matches the stored physical identification sample.

24. A system for authenticating more than one transaction card for PIN-less Internet transactions comprising:
an electronic storage location; and
a financial network host computer comprising a processor and a network adapter, wherein the financial network host computer system is connected with the electronic storage; wherein the processor comprises:
instructions to receive a first transaction request from a first merchant for a first transaction between the first merchant and a first cardholder using a first transaction card, wherein the first transaction requests comprises the first transaction card number;
instructions to receive a first physical identification sample from the cardholder;
instructions to hash the physical identification sample into a first hash of the physical identification sample;
instructions to retrieve at least one first stored hash associated with the first transaction card from electronic storage;
instructions to compare the first hash with first stored hash;
instructions to receive a second transaction request from a second merchant for a second transaction between the second merchant and a second cardholder using a second transaction card, wherein the second transaction requests comprises the second transaction card number;
instructions to receive a second physical identification sample from the cardholder, wherein the second physical identification sample comprises a type of physical identification sample that is different from the first physical identification sample type;
instructions to hash the physical identification sample into a second hash of the physical identification sample;
instructions to retrieve at least one second stored hash associated with the second transaction card from electronic storage; and
instructions to compare the second hash with second stored hash.

25. The method of claim 24 wherein the first physical identification sample is selected from the group consisting of a PC signature, a fingerprint, a retinal scan, a DNA sample, a hardware identifier, a keystroke dynamics sample, a voiceprint, and a software identifier.

26. The method of claim 24 wherein the second physical identification sample is selected from the group consisting of a PC signature, a fingerprint, a retinal scan, a DNA sample, a hardware identifier, a keystroke dynamics sample, a voiceprint, and a software identifier.

27. The system of claim 24 wherein the processor comprises instructions to send authorization for first transaction to the first merchant and instructions to send authorization for second transaction to the second merchant.
